(19) United States
(12) Patent Application Publication
(10) Pub. No.: US 2012/0092770 A1
(43) Pub. Date: Apr. 19, 2012

(54) NON-PERIODIC GRATINGS FOR SHAPING REFLECTED AND TRANSMITTED LIGHT IRRADIANCE PROFILES

(76) Inventors: Jingjing Li, Palo Alto, CA (US); David A. Fattai, Mountain View, CA (US); R. Stanley Williams, Portola Valley, CA (US); Raymond G. Beausoleil, Redman, WA (US)

(21) Appl. No.: 13/259,402

(22) PCT Filed: Jan. 29, 2010
(86) PCT No.: PCT/US10/22642

§ 371 Date: Dec. 14, 2011

(51) Int. Cl. G02B 5/18

(52) U.S. Cl. 359/572; 359/569

(57) ABSTRACT

Embodiments of the present invention are directed to planar sub-wavelength dielectric gratings that can be configured to control the beam profile of reflected and transmitted light. In one embodiment, a grating (200) includes a planar structure having a first surface and a second surface located opposite the first surface. The grating includes a non-periodic grating (201-203,210,212,216,218) formed within the first surface. For light incident on the first surface, a first portion of the light is reflected with a first wavefront shape and a first irradiance profile and a second portion of the light is transmitted with a second wavefront shape and a second irradiance profile.

### TECHNICAL FIELD

Embodiments of the present invention are directed to optical devices, and, in particular, to sub-wavelength gratings.

### BACKGROUND

Resonant effects in dielectric gratings were identified in the early 1990's as having promising applications to free-space optical filtering and sensing. Resonant effects typically occur in sub-wavelength gratings, where the first-order diffracted mode corresponds not to freely propagating light but not to a guided wave trapped in some dielectric layer. When a high-index-contrast grating is used, the guided waves are rapidly scattered and do not propagate very far laterally. As a result, the resonant feature can be considerably broadband and of high angular tolerance, which has been used to design novel types of highly reflective mirrors. Recently, sub-wavelength grating mirrors have been used to replace the top dielectric stacks in vertical-cavity surface-emitting lasers, and in novel micro-electromechanical devices. In addition to being more compact and relatively cheaper to fabricate, sub-wavelength grating mirrors also provide polarization control.

Although in recent years there have been a number of advances in sub-wavelength gratings, designers, manufacturers, and users of optical devices continue to seek grating enhancements that broadening the possible range of grating applications.

### BRIEF DESCRIPTION OF THE DRAWINGS

FIG. 1 shows a sub-wavelength grating operated in accordance with one or more embodiments of the present invention.

FIG. 2A shows a top plan view of a planar sub-wavelength grating configured with a one-dimensional grating pattern in accordance with one or more embodiments of the present invention.

FIGS. 2B-2C shows top plan views of two planar sub-wavelength gratings configured with two-dimensional gating patterns in accordance with one or more embodiments of the present invention.

FIG. 3 shows a cross-sectional view of lines from two separate grating sub-patterns revealing the phase acquired by reflected and transmitted light in accordance with one or more embodiments of the present invention.

FIG. 4 shows a cross-sectional view of lines from two separate grating sub-patterns revealing how the reflected and transmitted wavefront changes in accordance with one or more embodiments of the present invention.

FIG. 5A shows an isometric view of an exemplary reflected phase contour map produced by a grating pattern configured in accordance with one or more embodiments of the present invention.

FIG. 5B shows an isometric view of an exemplary transmitted phase contour map produced by a grating pattern configured in accordance with one or more embodiments of the present invention.

FIG. 6A shows a side view of a sub-wavelength grating configured to control the shape of reflected and transmitted wavefronts in accordance with one or more embodiments of the present invention.

FIG. 6B shows a side view of a sub-wavelength grating configured to focus reflected light to a focal point in accordance with one or more embodiments of the present invention.

FIG. 6C shows a side view of a sub-wavelength grating configured focus transmitted light to a focal point in accordance with one or more embodiments of the present invention.

FIG. 7A shows an isometric view of an exemplary reflected irradiance change contour map produced by a grating pattern configured in accordance with one or more embodiments of the present invention.

FIG. 7B shows an isometric view of an exemplary transmitted irradiance change contour map produced by a grating pattern configured in accordance with one or more embodiments of the present invention.

FIG. 7C shows reflectance and transmittance for the sub-wavelength gratings, shown in FIGS. 7A-7B, in accordance with one or more embodiments of the present invention.

FIG. 8 shows a plan view of a first example sub-wavelength grating configured in accordance with one or more embodiments of the present invention.

FIG. 9 shows a plan view of a second example sub-wavelength grating configured in accordance with one or more embodiments of the present invention.

FIG. 10 shows a plan view of a third example sub-wavelength grating configured in accordance with one or more embodiments of the present invention.

FIG. 11 shows a plot of reflectance and phase shift over a range of incident light wavelengths for a sub-wavelength grating in accordance with one or more embodiments of the present invention.

FIG. 12 shows a phase contour plot as a function of period and duty cycle obtained in accordance with one or more embodiments of the present invention.

FIG. 13 shows a reflectance contour plot as a function of period and duty cycle obtained in accordance with one or more embodiments of the present invention.

### DETAILED DESCRIPTION

Embodiments of the present invention are directed to planar sub-wavelength dielectric gratings (“SWGs”) that can be configured to control the beam profile of reflected and transmitted light. This can be accomplished by configuring a SWG with a non-periodic grating pattern to provide irradiance and phase front control for both reflected and transmitted light. In the following description, the term “light” refers to electromagnetic radiation with wavelengths in the visible and non-visible portions of the electromagnetic spectrum, including infrared and ultra-violet portions of the electromagnetic spectrum.

### Planar Sub-Wavelength Dielectric Gratings

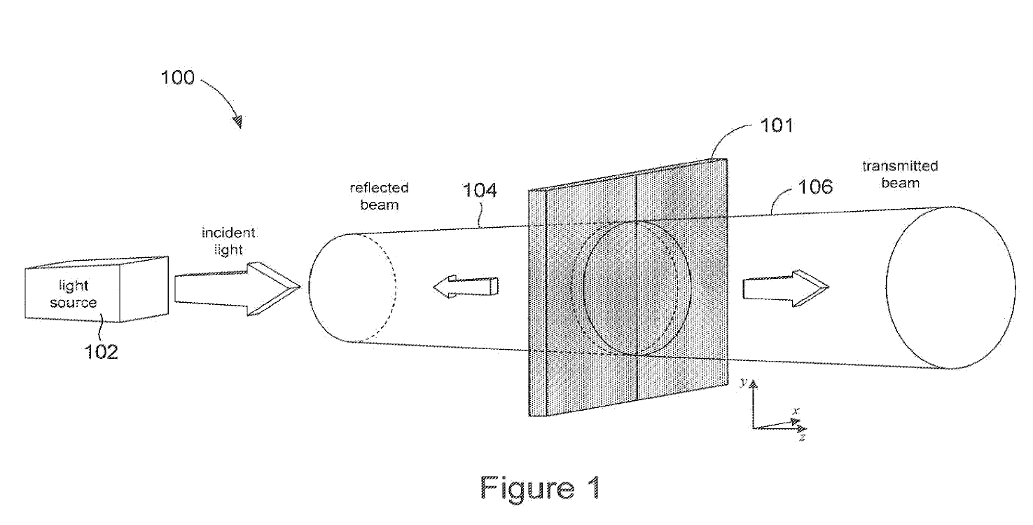

FIG. 1 shows a system for generating reflected and transmitted light in accordance with one or more embodiments of the present invention. As shown in FIG. 1, the system 100 includes a SWG 101 positioned to receive an incident beam of light from a light source 102. The light source 102 can be a laser, a light-emitting diode, or any other suitable source for generating substantially monochromatic light. The SWG 101 is configured to reflect a first portion of the incident light, represented by reflected beam 104, and transmit a second portion of the incident light, represented by transmitted beam 106. The SWG 101 is substantially lossless and can be configured with a non-periodic grating pattern to control phase front, or wavefront, of reflected and transmitted light. The non-periodic grating pattern can also be configured to control the irradiance magnitude of the light reflected from, and the light transmitted through, the SWG 100.

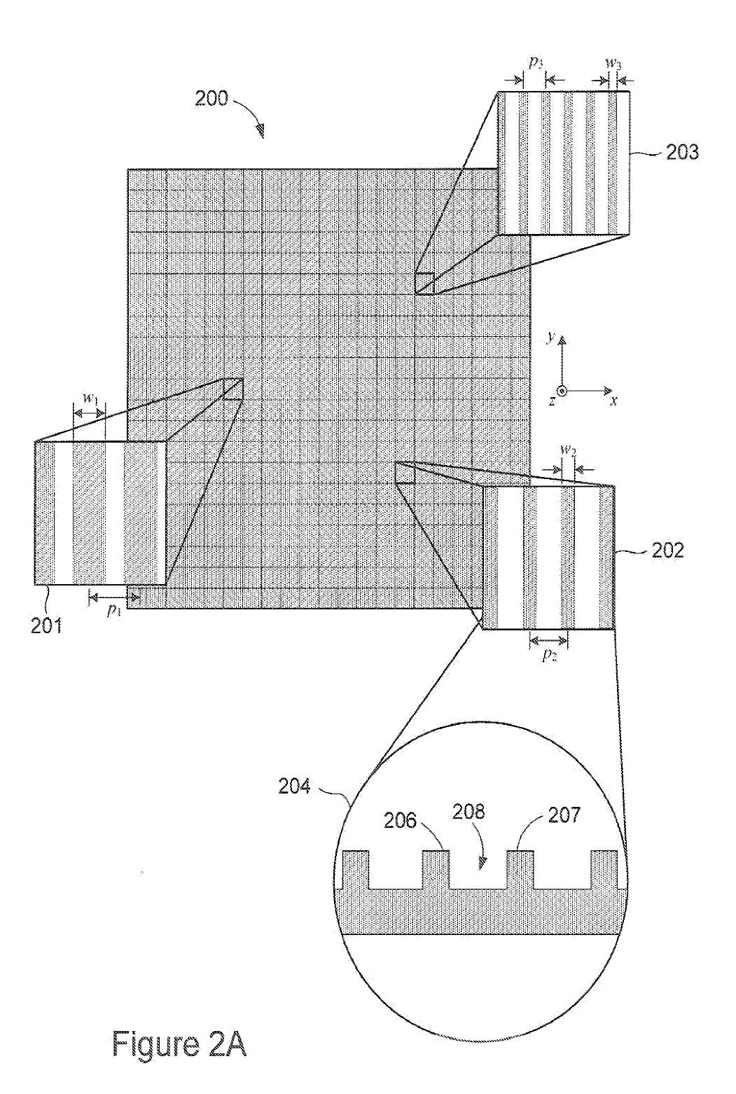

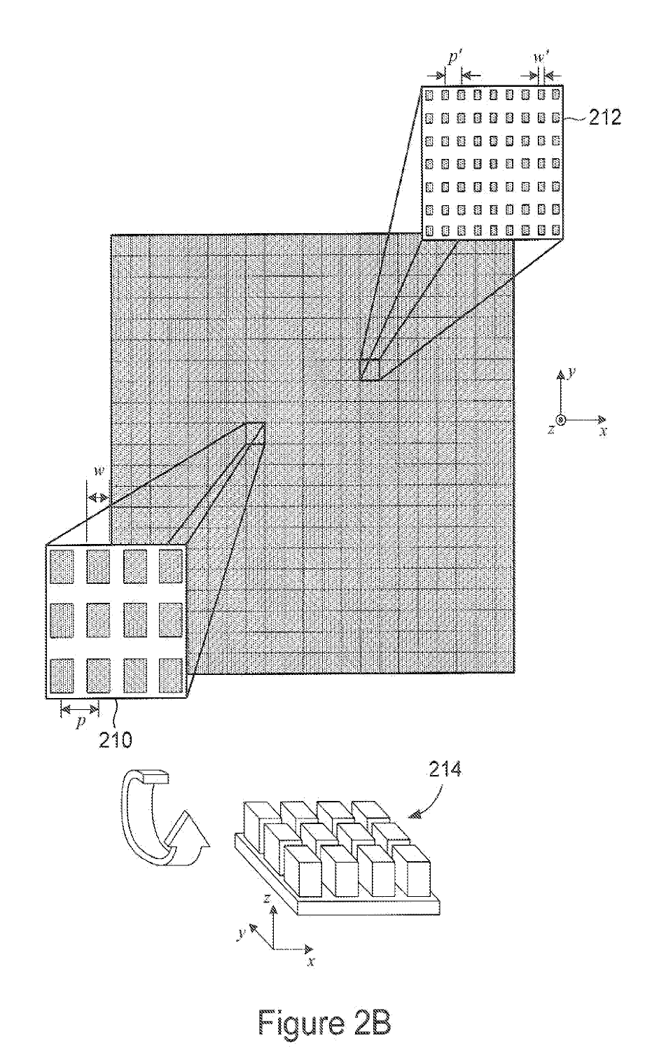

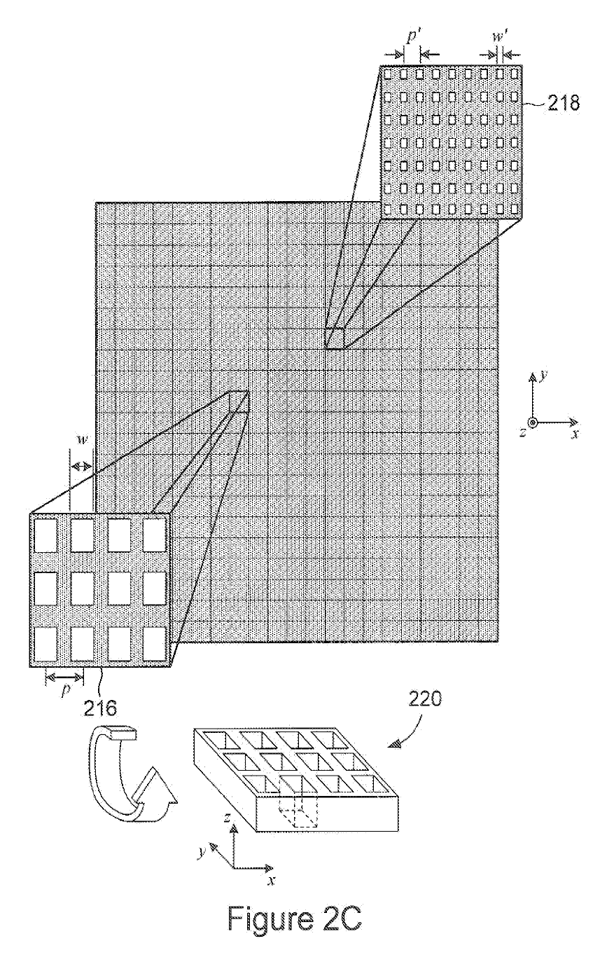

FIG. 2A shows a top plan view of a planar SWG 200 configured with a one-dimensional grating pattern in accordance with one or more embodiments of the present invention. The one-dimensional grating pattern is composed of a number of one-dimensional grating sub-patterns. In the example of FIG. 2A, three exemplary grating sub-patterns 201-203 are enlarged. Each grating sub-pattern comprises a number of regularly spaced wire-like portions of the grating layer 102 material called “lines” separated by grooves. The lines extend in the y-direction and are periodically spaced in the x-direction. FIG. 2A also includes an enlarged end-on view 204 of the grating sub-pattern 202. The end-on view 204 reveals the lines 206 and 207 are separated by a groove 208 extending in the z-direction. Each sub-pattern is characterized by a particular periodic spacing of the lines and by the line width in the x-direction. For example, the sub-pattern 201 comprises lines of width w, separated by a period p₁, the sub-pattern 202 comprises lines with width w₂ separated by a period p₂, and the sub-pattern 203 comprises lines with width w₃ separated by a period p₃.

The grating sub-patterns 201-203 form sub-wavelength gratings that can be configured to preferentially reflect and transmit incident light, provided the periods p₁, p₂, and p₃ are smaller than the wavelength of the incident light. For example, the lines widths can range from approximately 10 nm to approximately 300 nm and the periods can range from approximately 20 nm to approximately 1 μm depending on the wavelength of the incident light. The phase acquired by reflected and transmitted light, and the irradiance of reflected and transmitted light, is determined by the line thickness t, and the duty cycle η defined as:

$$η = \frac{w}{p}$$

where w is the line width and p is the period of the lines associated with a sub-pattern.

Note the SWG 200 can be configured to reflect or transmit the x-polarized component or the y-polarized component of the incident light by adjusting the period, line width and line thickness of the lines. For example, a particular period, line width and line thickness may be suitable for reflecting the x-polarized component but not for reflecting the y-polarized component. In this case, the y-polarized component can be transmitted through the SWG. On the other hand, a different period, line width and line thickness may be suitable for reflecting the y-polarized component but not for reflecting the x-polarized component. In this case, the x-polarized component can be transmitted through the SWG.

Embodiments of the present invention are not limited to one-dimensional gratings. A SWG can be configured with a two-dimensional, non-periodic grating pattern to reflect and transmit polarity insensitive light. FIGS. 2B-2C show top plan views of two example planar SWGs with two-dimensional grating patterns in accordance with one or more embodiments of the present invention. In the example of FIG. 2B, the SWG is composed of posts rather lines separated by grooves. The duty cycle and period can be varied in the x- and y-directions. Enlargements 210 and 212 show two different post sizes. FIG. 2B includes an isometric view 214 of posts comprising the enlargement 210. Embodiments of the present invention are not limited to square-shaped posts, in other embodiments that posts can be rectangular, circular, elliptical, or any other suitable shape. In the example of FIG. 2C, the SWG is composed of holes rather than posts. Enlargements 216 and 218 show two different hole sizes. FIG. 2C includes an isometric view 220 comprising the enlargement 216. Although the holes shown in FIG. 2C are square shaped, in other embodiments, the holes can be rectangular, circular, elliptical, or any other suitable shape.

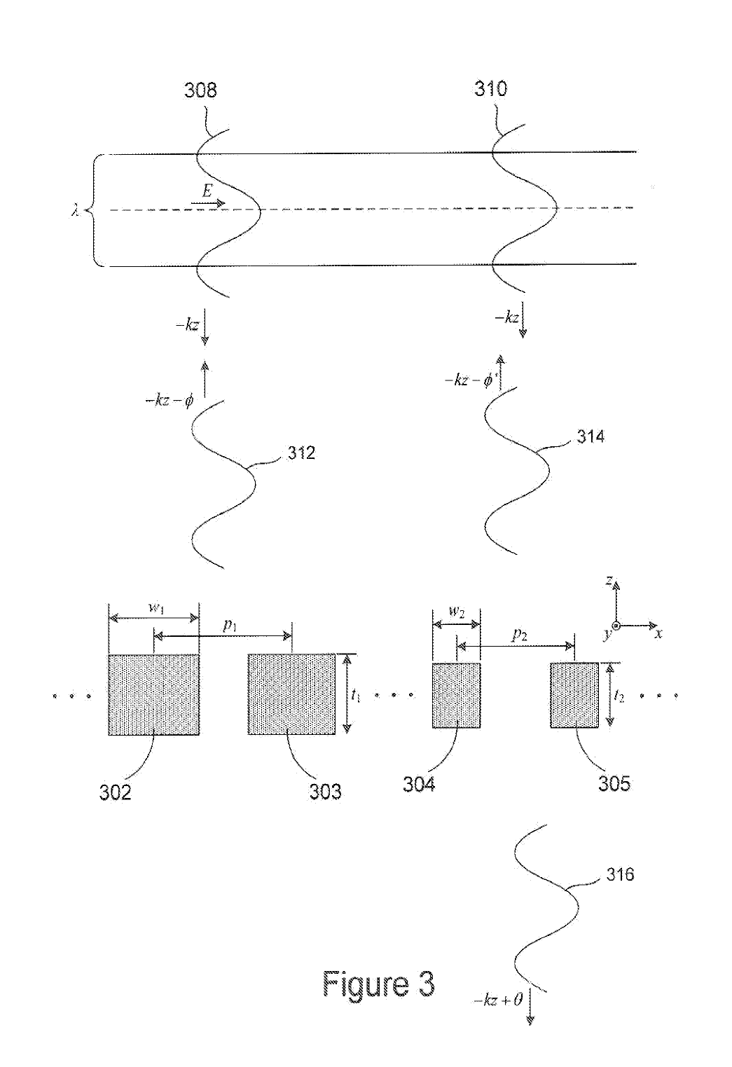

The grating sub-patterns described above can be configured to reflect and/or transmit incident light differently due to the different thicknesses, duty cycles, and periods selected for each of the sub-patterns. FIG. 3 shows a cross-sectional view of lines from two separate grating sub-patterns revealing the phase acquired by reflected and transmitted light in accordance with one or more embodiments of the present invention. For example, lines 302 and 303 can be lines in a first sub-pattern and lines 304 and 305 can be lines in a second sub-pattern located elsewhere within the same SWG. The thickness t₁ of the lines 302 and 303 is greater than the thickness t₂ of the lines 304 and 305, and the duty cycle η₁ associated with the lines 302 and 303 is also greater than the duty cycle η₂ associated with the lines 304 and 305. As shown in the example of FIG. 3, the incident waves 308 and 310 strike the lines 302-305 with approximately the same phase. Light incident on the lines 302-305 becomes trapped by the lines 302 and 303 and acquires a reflected phase shift, φ. On the other, the thickness and duty of the lines 304 and 305 is selected so that a first portion of the light incident on the lines 304 and 305 is reflected and a second portion is transmitted. As shown in the example of FIG. 3, wave 314 reflected from the lines 304 and 305 acquires a reflected phase shift φ′ (i.e., φ>φ′), and wave 316 represents the same portion of the light transmitted through the lines 304 and 305, acquiring a transmitted phase shift, θ.

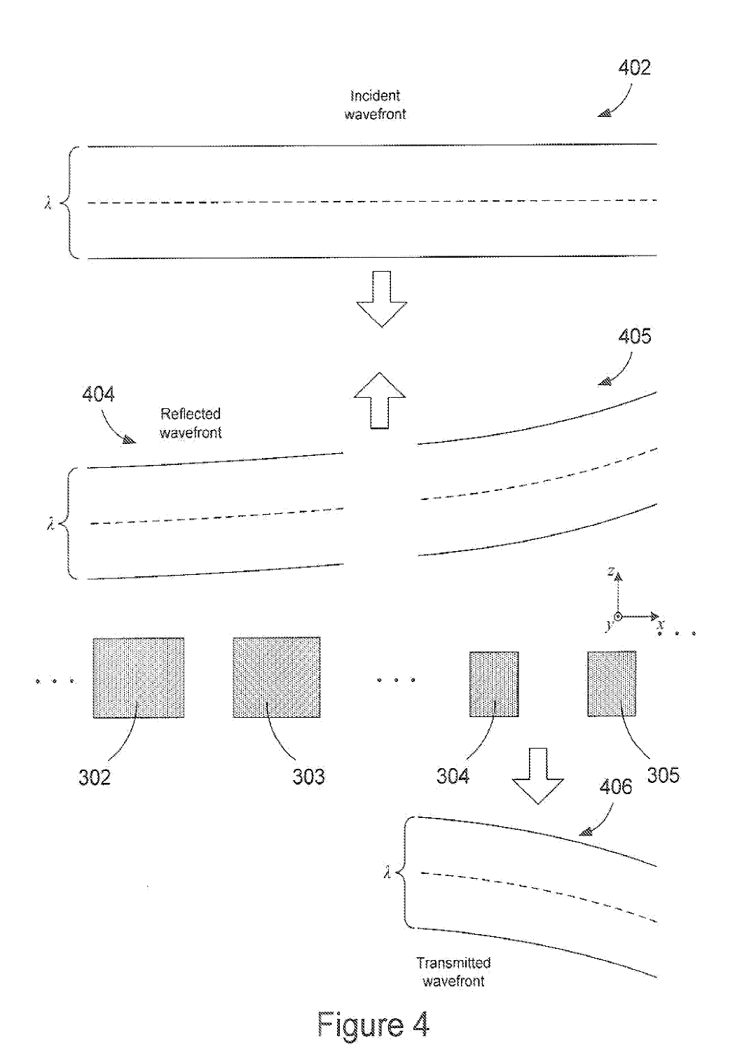

FIG. 4 shows a cross-sectional view of the lines 302-305 revealing how the wavefront changes in accordance with one or more embodiments of the present invention. As shown in the example of FIG. 4, incident light with a substantially uniform wavefront 402 strikes the lines 302-305 producing curved reflected wavefronts 404 and 405. The curved reflected wavefront 404 results from portions of the incident wavefront 402 interacting with the lines 302 and 303 with a relatively larger duty cycle η₁ and thickness t₁ than portions of the same incident wavefront 402 interacting with the lines 304 and 305 with a relatively smaller duty cycle η₂ and thickness t₂. The curved shapes of the reflected wavefronts 404 and 405 are consistent with the larger phase acquired by light striking the lines 302 and 303 relative to the smaller phase acquired by light striking the lines 304 and 305. Lines 304 and 305 are also configured to transmit a portion of the incident light resulting in a transmitted wavefront 406. Note that because a portion of the incident light striking the lines 304 and 305 is transmitted, the irradiance of the light reflected from the lines 304 and 305 is less than the irradiance of the light reflected from the lines 302 and 303.

The SWGs 200 can be configured to apply a particular phase change to reflected light while maintaining a very high reflectance over certain regions of the SWG and can be configured to apply a particular phase change to transmitted light while maintaining a very high transmittance.

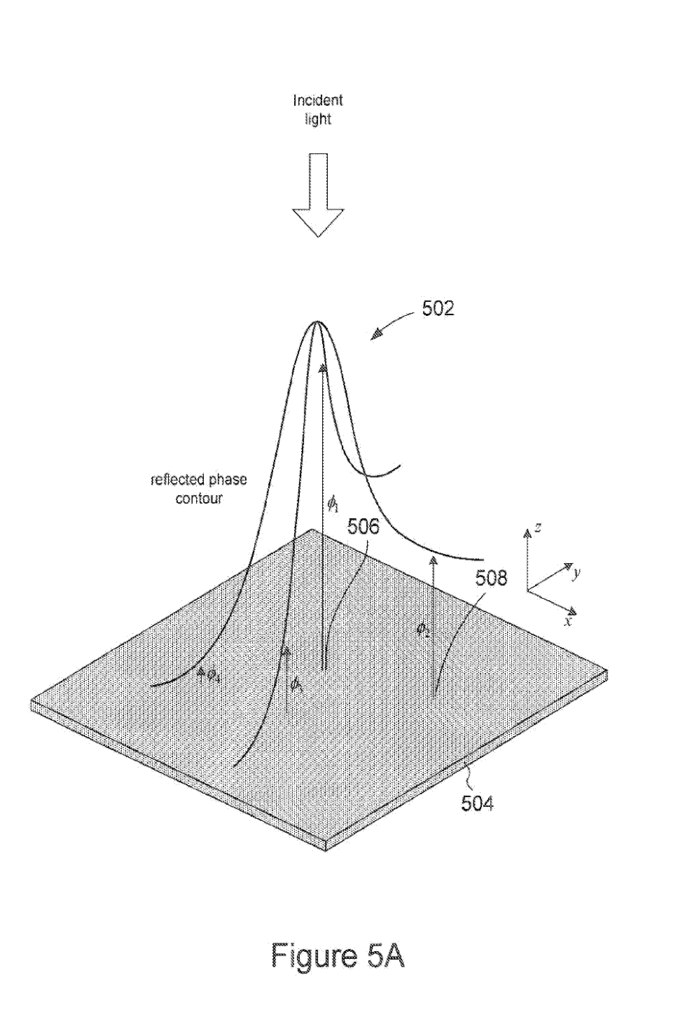

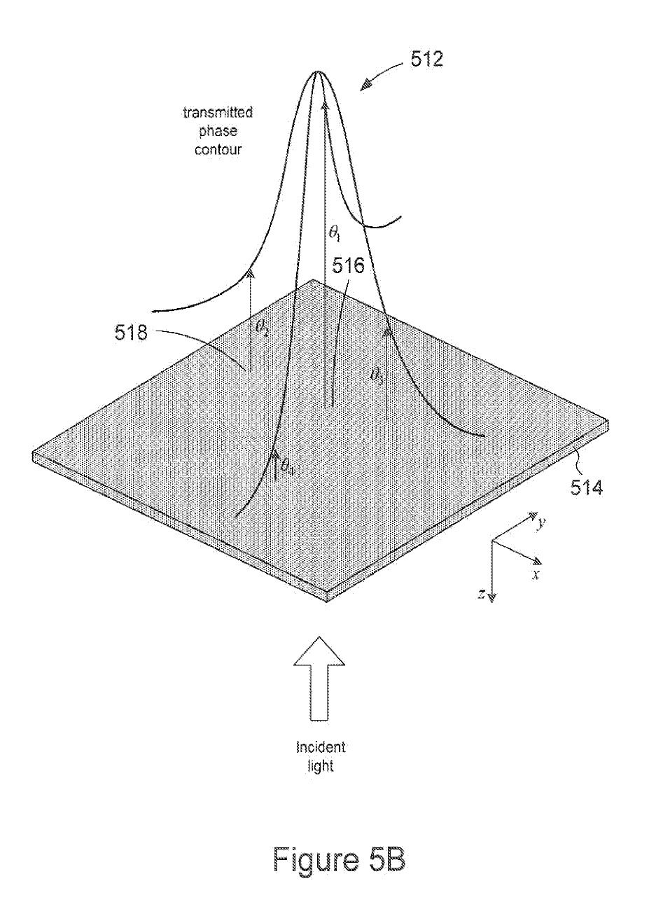

FIG. 5A shows an isometric view of an exemplary reflected phase contour map 502 produced by a particular grating pattern of a first SWG 504 in accordance with one or more embodiments of the present invention. The contour map 502 represents the magnitude of the phase change acquired by light reflected from the SWG 504. In the example shown in FIG. 5A, the grating pattern in the SWG 504 produces a contour map 502 with the largest magnitude in the phase acquired by the light reflected near the center of the SWG 504. The magnitude of the phase acquired by reflected light decreases away from the center of the SWG 504. For example, light reflected from a sub-pattern 506 acquires a phase φ₁, and light reflected from a sub-pattern 508 acquires a phase φ₂, where φ₁ is greater than φ₂.

On the other hand, FIG. 5B shows an isometric view of an exemplary transmitted phase contour map 512 produced by a particular grating pattern of a second SWG 514 in accordance with one or more embodiments of the present invention. The contour map 512 represents the magnitude of the phase change acquired by light transmitted through the SWG 514. In the example shown in FIG. 5B, the grating pattern in the SWG 514 produces a contour map 512 with the largest magnitude in the phase acquired by transmitted light occurring near the center of the SWG 514. The magnitude of the phase acquired by transmitted light decreases away from the center of the SWG 514. For example, light transmitted through a sub-pattern 516 acquires a phase θ₁, and light transmitted through a sub-pattern 518 acquires a phase θ₂, where θ₁ is greater than θ₂.

The phase change shapes the wavefront of light reflected from, and light transmitted through, the SWG. For example, as described above with reference to FIG. 3, lines having a relatively larger duty cycle produce a larger phase shift in reflected light than lines having a relatively smaller duty cycle. As a result, a first portion of a wavefront reflected from lines having a first duty cycle lags behind a second portion of the same wavefront reflected from a different set of lines configured with a second relatively smaller duty cycle. Embodiments of the present invention include selectively patterning the grating layer of a SWG to control the reflected and transmitted phase across the SWG, and ultimately control the reflected and transmitted wavefronts.

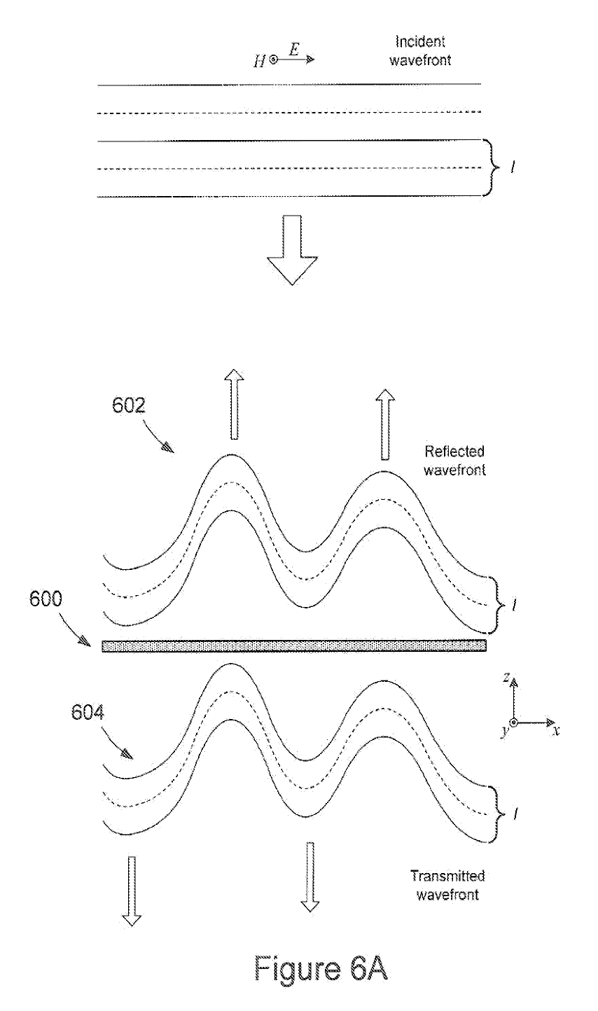

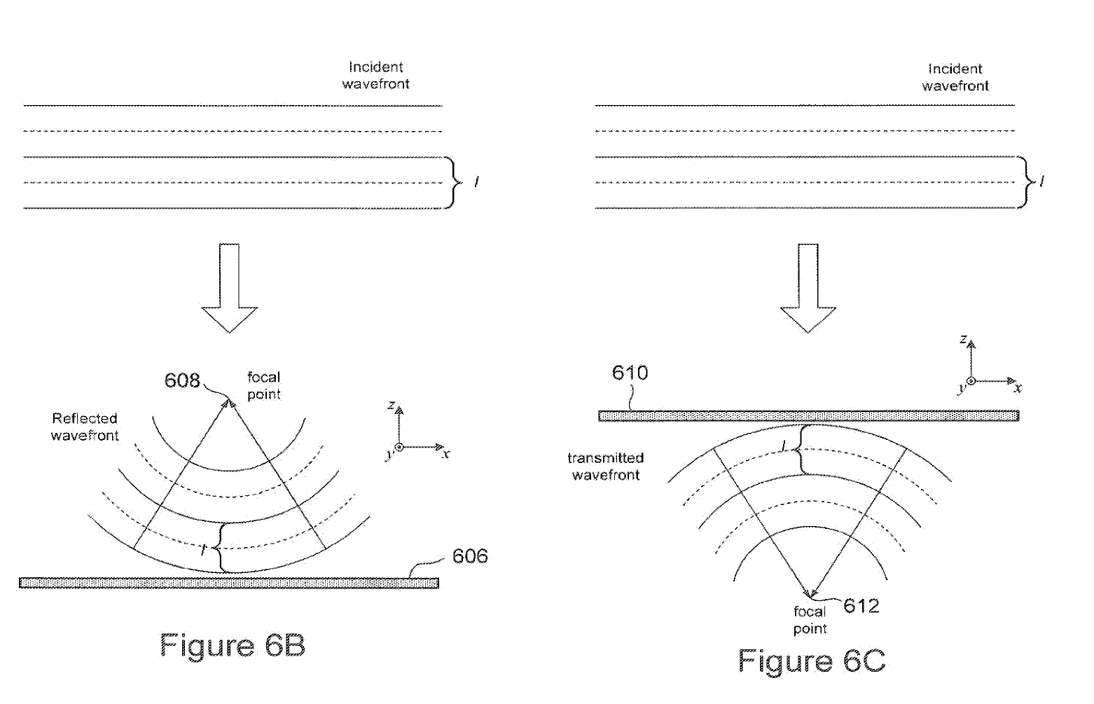

FIG. 6A shows a side view of a SWG 600 with a non-periodic grating pattern configured to control the reflected and transmitted wavefront in accordance with one or more embodiments of the present invention. In the example of FIG. 6, the SWG 600 is configured so that incident light 602 is reflected with a wavefront 604 and transmitted with a wavefront 606.

A SWG can be configured to operate as a converging mirror or a converging lens. FIG. 6B shows a side view of a SWG 606 configured with a grating layer that focuses reflected light to a focal point 608 in accordance with embodiments of the present invention. In the example of FIG. 6B, the SWG 606 is configured with a grating pattern that reflects at least a portion of the incident light with a wavefront corresponding to focusing the reflected light at the focal point 608. On the other hand, FIG. 6C shows a side view of a SWG 610 configured with a grating layer that focuses transmitted light to a focal point 612 in accordance with embodiments of the present invention. In the example of FIG. 6C, the SWG 606 is configured with a grating pattern that transmits at least a portion of the incident light with a wavefront corresponding to focusing the transmitted light at the focal point 612. In other embodiments, a SWG can be configured to operate as a diverging mirror or a diverging lens.

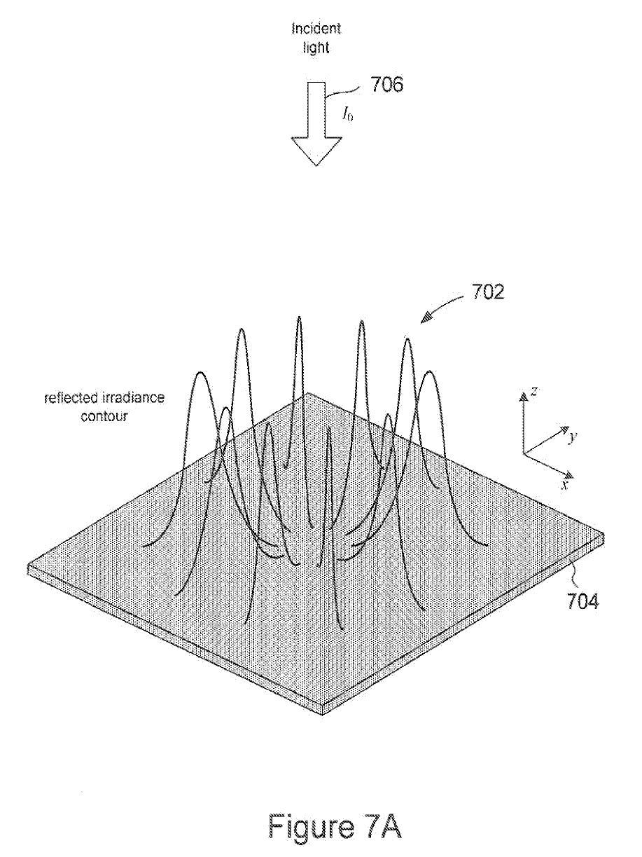

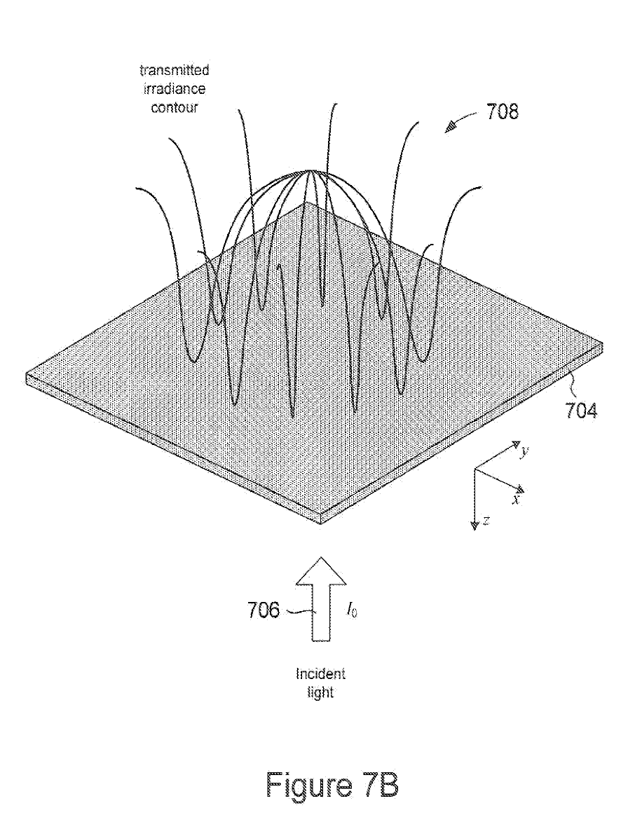

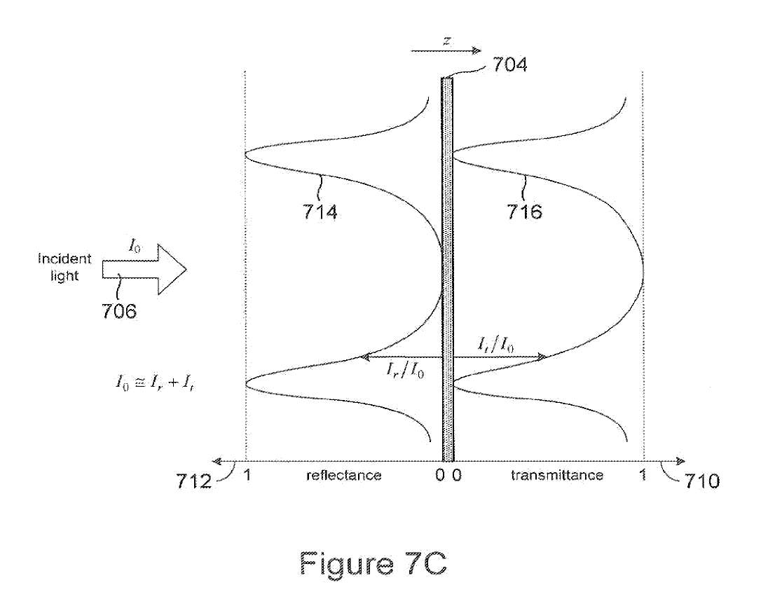

The SWGs 200 can be configured to control the irradiance profile of reflected and transmitted light with little to no loss. FIG. 7A shows an isometric view of an exemplary reflected irradiance contour map 702 produced by a particular grating pattern of a SWG 704 in accordance with one or more embodiments of the present invention. The contour map 702 represents the irradiance over the surface of the SWG 704 of the light reflected from the SWG 704. In the example shown in FIG. 7A, the gating pattern of the SWG 704 is configured so that the irradiance of the light reflected from the SWG 704 is annular, or ring shaped. In other words, viewing the reflected beam of light along the z-axis reveals an annular, or ring-shaped, light pattern. Light that is not reflected by the SWG 704 is transmitted through the SWG 704 with little to no loss. FIG. 7B shows an irradiance contour map 708 of light transmitted through the SWG 704 in accordance with one or more embodiments of the present invention. The contour map 708 represents the irradiance over the surface of the SWG 704 for light transmitted through the SWG 704. Viewing the transmitted light along the z-axis reveals a dark annular, or ring-shaped, region. FIG. 7C shows reflectance and transmittance for the SWG 704 in accordance with one or more embodiments of the present invention. In FIG. 7C, axis 710 represents the transmittance and axis 712 represents the reflectance. Curve 714 represents a cross-sectional view of the reflectance associated with light reflected from the SWG 704, and curve 716 represents a cross-sectional view of the transmittance associated with light transmitted through the SWG 704. Curve 714 reveals the shape of the irradiance profile of the light reflected from the SWG 704, and curve 716 reveals the shape of the irradiance profile of the light transmitted through the SWG 704.

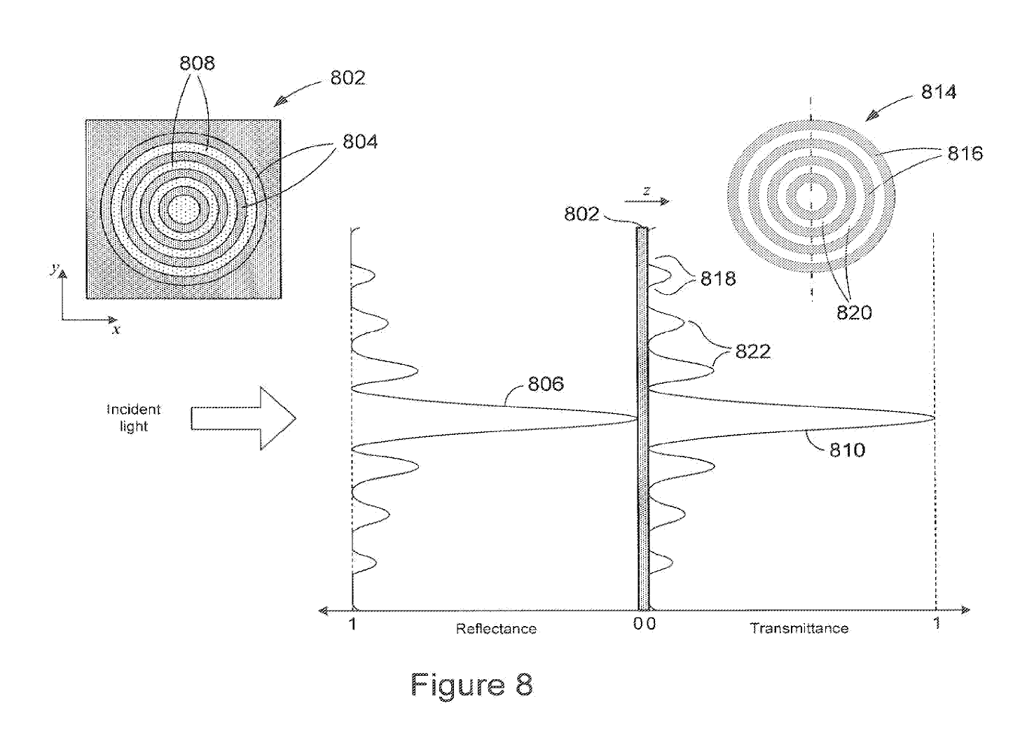

Embodiments of the present invention include configuring SWGs to produce a wide variety of irradiance profiles for reflected and transmitted beams. FIG. 8 shows a plan view of an example SWG 802 configured in accordance with one or more embodiments of the present invention. FIG. 8 includes reflectance and transmittance plots corresponding to light reflected from and transmitted through the SWG 802. Dark shaded annular regions 804 represent regions of the SWG 802 that are configured to reflect incident light as represented by reflectance curve 806, and unshaded annular regions 808 represent regions of the SWG 802 configured to transmit light as represented by transmittance curve 810. FIG. 8 also includes a cross-sectional view 812 of a beam of light transmitted through the SWG 802. Dark annular regions 816 represent dark portions of the transmitted beam (i.e., reflected portions of the incident beam) and correspond to regions 818 of the curve 810 where the transmittance is approximately zero. Unshaded annular regions 818 represent concentric annular-shaped luminous portions of the transmitted beam and correspond to regions 822 of the curve 810 where the transmittance is not zero. The waveform of the transmittance curve 810 shows the luminance or amplitude of the annular regions decreases away from the center of the beam. The resulting beam is referred to as an Airy beam. An Airy beam exhibits little to no diffraction or does not spread out appreciably as the beam propagates.

In other embodiments, SWGs can be configured to generate Bessel beams which have similar transmittance curve and concentric luminance annular regions. Bessel beams also have the characteristic amplitude decrease away from the center of the beam, but the amplitude is characterized by a Bessel function. Bessel beams, like Airy beams, have the property of substantially little to no diffraction as the beam propagates

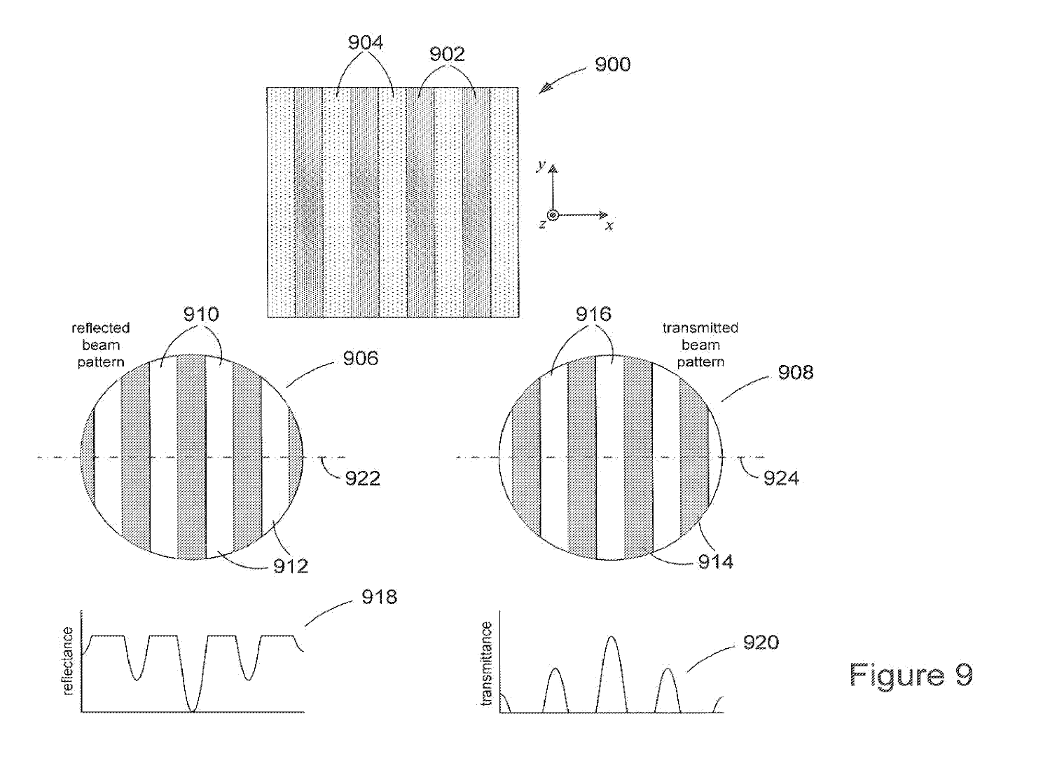

Embodiments of the present invention include configuring SWGs to generate other kinds of irradiance profiles within transmitted and reflected beams. FIG. 9 shows a plan view of an example SWG 900 configured in accordance with one or more embodiments of the present invention. Shaded regions 902 represent regions of the SWG 900 configured to reflect incident light, and lightly shaded regions 904 represent regions of the SWG 900 configured transmit incident light. FIG. 9 includes a cross-sectional view of a reflected beam pattern 906 and a cross-sectional view of a transmitted beam pattern 908. Dark regions 910 correspond to portions of the incident beam that are transmitted through the regions 904 of the SWG 900, and unshaded regions 912 correspond to portions of incident beam that are reflected from the regions 902 of the SWG 900. On the other hand, dark regions 914 correspond to portions of the incident beam that are reflected by regions 902 of the SWG 900, and unshaded regions 916 correspond to portions of incident beam that are transmitted through the regions 904 of the SWG 900. FIG. 9 also include a reflectance and transmittance plots 918 and 920. Reflectance plot 918 represent the irradiance profile along a line 922 of the reflected beam and shows the amplitude of increases away the center of the beam. By contrast, transmittance plot 920 represents the irradiance profile along a line 924 of the transmitted beam 908 and shows the amplitude of transmitted portions of the beam 908 decreases away from the center of the beam.

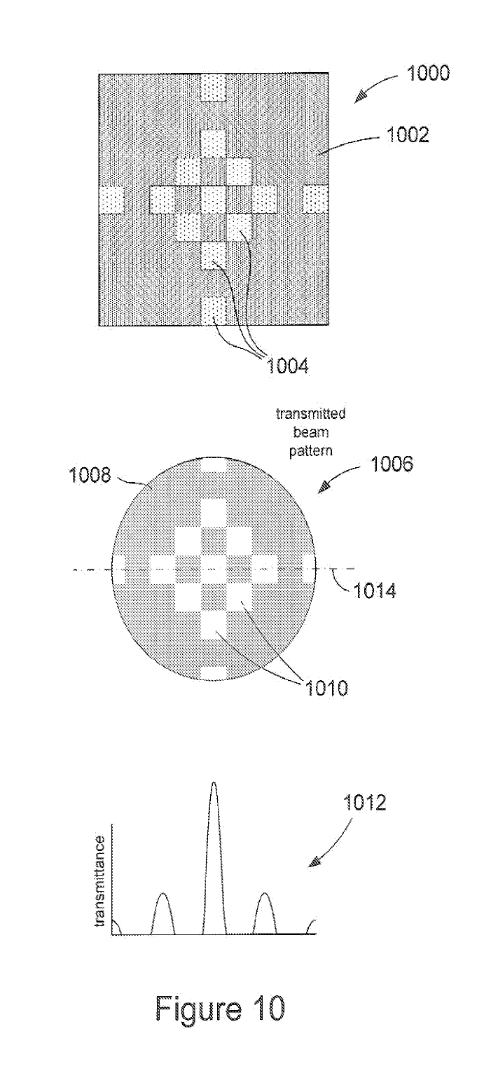

FIG. 10 shows a plan view of a SWG 1000 configured in accordance with one or more embodiments of the present invention. Shaded region 1002 represent regions of the SWG 1000 configured to reflect incident light, and lightly shaded regions 1004 represent regions of the SWG 1000 configured transmit incident light. FIG. 10 includes a cross-sectional view of a transmitted beam pattern 1006. Dark regions 1008 correspond to portions of the incident beam that are reflected from the regions 1002 of the SWG 1000, and unshaded regions 1010 correspond to portions of incident beam that are transmitted through the regions 1004 of the SWG 1000. FIG. 10 also include a transmittance plot 1012 that represents the irradiance profile along a line 1014.

### Designing and Fabricating Sub-Wavelength Gratings

In certain embodiment, SWGs can be fabricated in a single layer or membrane composed of a high index material. For example, the SWGs can be composed of, but is not limited to, an elemental semiconductor, such as silicon (“Si”) or germanium (“Ge”); a III-V semiconductor, such as gallium arsenide (“GaAs”); a II-VI semiconductor; or a non-semiconductor material, such silicon carbide (“SiC”). In other embodiments, SWGs can be composed of a grating layer disposed on a surface of a substrate, where the grating layer is composed of a relatively higher refractive index material than the substrate. For example, the gating layer can be composed the material described above and the substrate can be composed of quartz or silicon dioxide (“SiO₂”), aluminum gallium arsenide (“AlGaAs”), or aluminum oxide (“Al₂O₃”).

Embodiments of the present invention include a number of ways in which a SWG can be designed to reflect and transmit incident light and introduce a desired phase front to reflected and transmitted light. A first method includes determining a reflection coefficient profile for the grating layer of a SWG. The reflection coefficient is a complex valued function represented by:

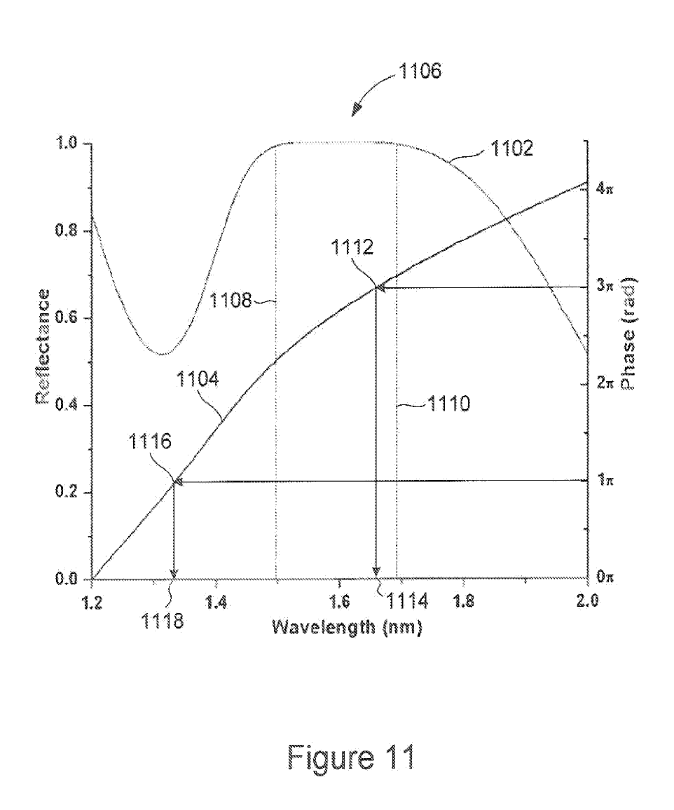

r(λ)=\sqrt{R(λ)}e^{iφ(λ)}

where R(λ) is the reflectance of the SWG, and φ(λ) is the phase shift or change produced by the SWG. FIG. 11 shows a plot of reflectance and phase shift over a range of incident light wavelengths for a SWG composed of Si disposed on a quartz substrate in accordance with one or more embodiments of the present invention. In this example, the grating layer is configured with a one-dimensional grating pattern and is operated at normal incidence with the electric field polarized perpendicular to the lines comprising the grating layer. In FIG. 11, curve 1102 corresponds to the reflectance R(λ) and curve 1104 corresponds to the phase shift φ(λ) produced by the SWG for the incident light over the wavelength range of approximately 1.2 μm to approximately 2.0 μm. The reflectance and phase curves 1102 and 1104 can be determined using either the well-known finite element method or rigorous coupled wave analysis. Due to the strong refractive index contrast between Si and air, the grating has a broad spectral region of high reflectivity 1106 and transmission for other wavelengths. However, curve 1104 reveals that the phase of the reflected light varies across the entire high-reflectivity spectral region between dashed-lines 1108 and 1110.

When the spatial dimensions of the period and width of the lines is changed uniformly by a factor α, the reflection coefficient profile remains substantially unchanged, but with the wavelength axis scaled by the factor α. In other words, when a grating has been designed with a particular reflection coefficient R₀ at a free space wavelength λ₀, a new grating with the same reflection coefficient at a different wavelength λ can be designed by multiplying all the grating geometric parameters, such as the period, line thickness, and line width, by the factor α=λ/λ₀, giving r(λ)=r₀(λ/α)=r₀(λ₀).

In addition, a grating can be designed with |R(λ)═→1, but with a spatially varying phase, by scaling the parameters of the original periodic grating non-uniformly within the high-reflectivity spectral window 1106. Suppose that introducing a phase φ(x, y) on a portion of light reflected from a point on the SWG with transverse coordinates (x, y) is desired. Near the point (x, y), a nonuniform grating with a slowly varying grating scale factor α(x, y) behaves locally as though the grating was a periodic grating with a reflection coefficient R₀(λ/α). Thus, given a periodic grating design with a phase φ₀ at some wavelength λ₀, choosing a local scale factor α(x, y)=λ/λ₀ gives φ(x, y)=φ₀ at the operating wavelength λ. For example, suppose that introducing a phase of approximately 3π on a portion of the light reflected from a point (x, y) on a SWG design is desired, but the line width and period selected for the point (x, y) introduces a phase of approximately π. Referring to the plot of FIG. 11, the desired phase φ₀=3π corresponds to the point 1112 on the curve 1104 and the wavelength λ₀≈1.67 μm 1114, and the phase π associated with the point (x, y) corresponds to the point 1116 on the curve 704 and the wavelength λ≈1.34 μm. Thus the scale factor is α(x, y)=λ/λ₀=1.34/1.67=0.802, and the line width and period at the point (x, y) can be adjusted by multiplying by the factor α in order to obtain the desired phase φ₀=3π at the operating wavelength λ=1.34 μm.

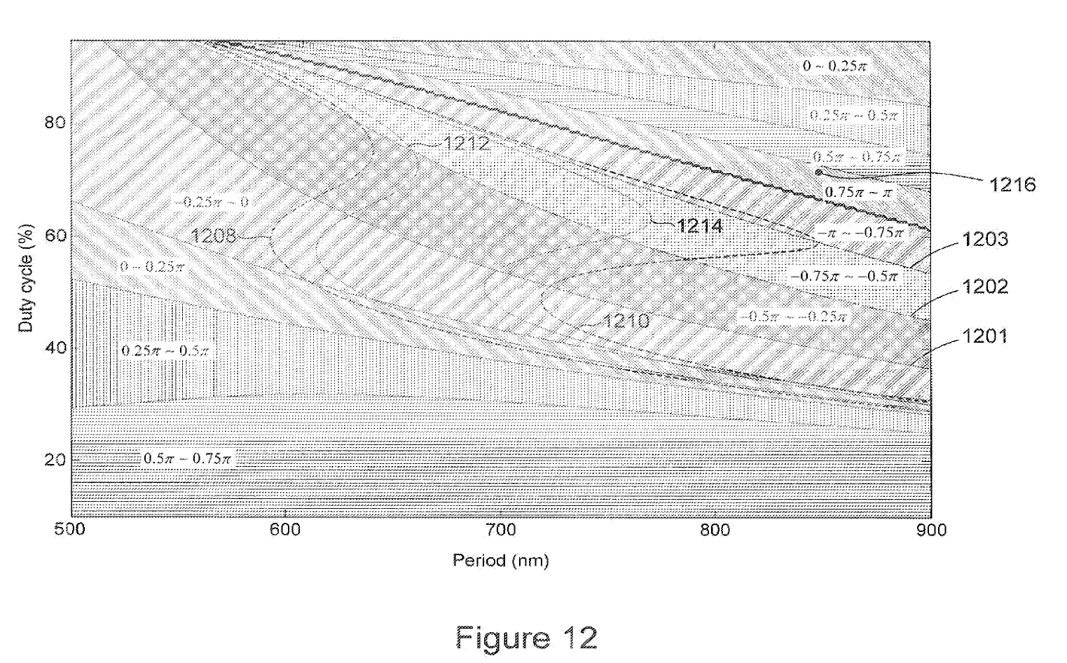

The plot of reflectance and phase shift versus a range of wavelengths shown in FIG. 11 represents one way in which parameters of a SWG, such as line width, line thickness and period, can be determined in order to introduce a particular phase to light reflected from a particular point of the SWG. In other embodiments, phase variation as a function of period and duty cycle can also be used to construct a SWG. FIG. 12 shows a phase contour plot of phase variation as a function of period and duty cycle obtained in accordance with one or more embodiments of the present invention using either the well-known finite element method or rigorous coupled wave analysis. Contour lines, such as contour lines 1201-1203, each correspond to a particular phase acquired by light reflected from a grating pattern with a period and duty cycle lying anywhere along the contour. The phase contours are separated by 0.257π rad. For example, contour 1201 corresponds to periods and duty cycles that apply a phase of −0.25π rad to reflected light, and contour 1202 corresponds to periods and duty cycles that apply a phase of −0.57π rad to reflected light. Phases between −0.257π rad and −0.5π rad are applied to light reflected from a SWG with periods and duty cycles that lie between contours 1201 and 1202. A first point (p, η) 1204, corresponding to a grating period of 700 nm and 54% duty cycle, and a second point (p, η) 1206, corresponding to a grating period of 660 nm and 60% duty cycle, both of which lie along the contour 1201. A grating pattern with a period and duty cycle represented by the first point 1204 introduces the same phase φ=−0.257π rad to reflected light as a grating pattern represented by the second point 1206.

FIG. 12 also includes two reflectivity contours for 95% and 98% reflectivity overlain on the phase contour surface. Dashed-line contours 1208 and 1210 correspond to 95% reflectivity, and solid line contours 1212 and 1214 correspond to 98% reflectivity. Points (p, η, φ) that lie anywhere between the contours 1208 and 1210 have a minimum reflectivity of 95%, and points (p, η, φ) that lie anywhere between the contours 1212 and 1214 have a minimum reflectivity of 98%.

The points (p, η, φ) represented by the phase contour plot can be used to select periods and duty cycles for a grating that can be operated as a particular type of mirror with a minimum reflectivity, as described below in the next subsection. In other words, the data represented in the phase contour plot of FIG. 12 can be used to design SWG optical devices. In certain embodiments, the period or duty cycle can be fixed while the other parameter is varied to design and fabricate SWGs. In other embodiments, both the period and duty cycle can be varied to design and fabricate SWGs.

FIG. 13 shows an amplitude contour plot as a function of period and duty cycle obtained in accordance with one or more embodiments of the present invention using either the well-known finite element method or rigorous coupled wave analysis. Contour lines, such as contour lines 1301-1303, each correspond to a particular amplitude of light reflected from a grating pattern where the period and duty cycle lie along the contours. For example, contour 1301 corresponds to periods and duty cycles with a reflectance |R|²≅0.8 and a transmittance of |T|²≅0.2.

The data represented in the contour plots shown in FIGS. 12 and 13 can be used in combination to configure SWGs with particular non-periodic grating patterns that produce a desired reflected or transmitted phase front and/or desired reflectance and transmittance. For example, suppose it is desired that a particular sub-region of a SWG have a reflectance of |R|²≅0.6 and a reflected phase shift of approximately φ≅0.7π. Point 1216 of the contour plot shown in FIG. 12 and point 1304 of the contour plot shown in FIG. 13 satisfy this requirement. Both points 1216 and 1304 correspond to a period of approximately 850 nm and a duty cycle of approximately 75%, which are the parameters used to configure the sub-region.

A SWG can be fabricated in 450 nm thick amorphous Si deposited on a quartz substrate at approximately 300° C. using plasma-enhanced chemical vapor deposition. The grating pattern can be defined using electron beam lithography with a commercial hydrogen silsequioxane negative resist, FOX-12®, exposed at 200 μC/cm² and developed for 3 minutes in a solution of MIF 300 developer. After development, the grating patterns can be descummed using CH₄/H₂ reactive ion etching to clear the resist residue from the grooves between the grating lines. The Si lines can be formed by dry etching with HBr/O₂ chemistry. At the end of the process, a 100 nm thick resist layer may remain on top of the Si lines, which was included in the numerical simulation results described below. The grating can also be fabricated using photolithography, nano-imprint lithography, or e-beam lithography with a positive tone resist.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A grating comprising:
a planar structure (200) having a first surface and a second surface located opposite the first surface; and
a non-periodic, sub-wavelength grating (201-203,210,212,216,218) formed within the first surface, wherein for light incident on the first surface, a first portion of the light is reflected with a first wavefront shape and a first irradiance profile and a second portion of the light is transmitted with a second wavefront shape and a second irradiance profile.

2. The grating of claim 1 wherein planar structure further comprises a continuous membrane.

3. The grating of claim 1 wherein the planar structure further comprises a grating layer disposed on a substrate, the grating layer having a higher refractive index than the substrate.

4. The grating of claim 1 wherein the non-periodic grating further comprises a one-dimensional non-periodic grating pattern.

5. The grating of claim 4 wherein the non-periodic grating pattern further comprises lines separated by grooves (204).

6. The grating of claim 1 wherein the non-periodic grating further comprises a two-dimensional non-periodic grating pattern.

7. The grating of claim 1 wherein the two-dimensional grating pattern further comprises posts (214) extending substantially perpendicular to the planar structure.

8. The grating of claim 1 wherein the two-dimensional grating pattern further comprises holes (220) extending substantially perpendicular to the planar structure.

9. A system for generating reflected and transmitted light, the systems comprising:
a light source (102); and
a non-periodic, sub-wavelength grating (101) configured in accordance with claim 1, and positioned to receive light emitted from the light source and produce a reflected beam and a transmitted beam.

10. The system of claim 9, wherein the light source further comprises a substantially monochromatic light source.

11. The system of claim 9 wherein the non-periodic, sub-wavelength grating is configured so that the first wavefront shape corresponds to focusing the reflected beam to a focal point.

12. The system of claim 9 wherein the non-periodic, sub-wavelength grating is configured so that the second wavefront shape corresponds to focusing the transmitted beam to a focal point.

13. The system of claim 9 wherein the non-periodic, sub-wavelength grating is configured so that the first irradiance profile produces the reflected beam with an Airy irradiance profile.

14. The system of claim 9 wherein the non-periodic, sub-wavelength grating is configured so that the second irradiance profile produces the transmitted beam with an Airy irradiance profile.

15. The system of claim 9 wherein the irradiance of the reflected beam and the irradiance of the transmitted approximately equals the irradiance of the incident light generated by the light source.
